(19) United States
(12) Patent Application Publication
(10) Pub. No.: US 2002/0038376 A1
(43) Pub. Date: Mar. 28, 2002

(54) Time shifting over a global communication network

(76) Inventor: Christopher I. Halliday, Collegeville, PA (US)

Correspondence Address: Christopher I. Halliday, 59 Windsor Place, Collegeville, PA, 19426, US

(21) Appl. No.: 09/922,487

(22) Filed: Aug. 3, 2001

Related U.S. Application Data
(60) Provisional application No. 60/233,616, filed on Sep. 18, 2000.

(51) Int. Cl. G06F 15/16

(52) U.S. Cl. 709/231; 709/245

(57) ABSTRACT

A time shifting method for the receipt and optionally the recordation of broadcasts of audio and video works of authorship over a Global Communication Network.

### CROSS REFERENCE TO RELATED APPLICATIONS

This application claims the benefit of U.S. Provisional Application No. 60/258,329, filed Sep. 18, 2000, the content of which is hereby incorporated by reference.

### BACKGROUND OF THE INVENTION

Over two hundred years ago, the United States enacted Copyright Laws to protect the ownership rights of authors and their respective expressive works. For example, the Copyright Laws protect works of authorship such as fiction, music and art. These Laws work to ensure that the creators are compensated when the work is used by others.

In December of 1999, the Recording Industry Association of America filed a lawsuit against Napster™, Inc., accusing the company of encouraging the illegal copying and distribution of copyrighted musical works of art on the Internet. The Recording Industry Association of America asserted that the Copyright Laws inure in the creators of certain literary and artistic works the right to insure that unauthorized people do not use the works for unauthorized purposes. In other words, the authors hold the Copyright. However, the authors can give up the exclusive right to publish and distribute to other authorized entities for a limited time or permanently, the works of authorship.

Both the Legislature and the Courts have ruled that people have significant rights to make and use copies of the original works of authorship described above in narrow exceptions of the Copyright Laws. For example in 1984 Supreme Court ruled that “time-shifting”—taping programs on VCR's for watching later— is not a violation of Copyright. Further, in 1992 Congress passed the Audio Home Recording Act, which permits people to make copies of music for personal use. These Laws assure consumers that they cannot be suited for copy infringement for making non-commercial copies of recordings for their personal use.

Streaming technology has been one method envisioned to enable users to make more legitimate use of audio and video media on the Internet, Extranet or Intranet. In simple terms, streaming technology allows a user to view or hear digitized content as it is being downloaded from an Intranet, Extranet, or the Internet. That is, it allows information to be accessed in virtual real time as the file is being transmitted from another location. As the file is used, its remnants are discarded. This is in direct contrast with the more typical procedure whereby a user must download the entire file before accessing it, a process that can monopolize tremendous amounts of both time and disk space, depending on such factors as the size and nature of the file, modem speed, and Internet connection.

As might be expected, media files are quite large, commanding tremendous amounts of bits and computing power. A typical audio CD uses about 10.09 MB per minute of storage or about 650 MB per disk. A 28.8 kbps modem can transfer a 10MB file in about an hour. Without compression, a 4 minute, CD-quality song would take about 5 hours to download using a standard modem. Aside from the size of the file, maintaining the quality of the sound is also problematic. CD-quality digital audio is typically stored as 16-bit samples and requires 44,100 samples per second to capture the full range of frequencies that a listener can hear. This results in a data rate of over 700 kbps. With stereo files, the data rate doubles to 1400 kbps.

Although typical access to the Internet is limited to only 28.8 kbps, the data for stereo files is far too large to be delivered in real-time. Solutions such as reducing the sampling rate to 8 KHz and/or using 8-bit samples typically results in greatly inferior sound quality and still require 64 kbps.

With the forthcoming broadband technology, wireless Internet, satellite radio and video broadcasting and cable modems, data transfer rates have skyrocketed. Unfortunately, few households and business have access to such technology.

The mechanics of streaming typically begin by a visitor using a Web browser, accessing a web page and then clicking on a link to a streaming media presentation. This presentation, whether a single file or group of files, typically resides on the host's server. The host server immediately creates a small metafile and sends it to the visitor's Web browser. Upon downloading, the metafile, also known as a RAM file, notifies the user's PC which type of media player (RealPlayer, Quicktime, etc.) is to be used. Once the player is opened, it utilizes information within the metafile to search for the address(es)of the media presentation mentioned in the link. The player reads the link in the metafile and requests the presentation directly from the host server. The host server, upon receiving the request, streams the media files to the player, adjusting for the bandwidth being used. The player begins playing the presentation as the initial packets of data are being received, and keeps playing the file as the remaining parts arrive.

More specifically, when a user clicks on a link, a two-way TCP connection is opened between the player and the host server. This connection is used to send commands, such as when to pause, stop, etc., from the client to the server and vice versa, and is also used for security purposes. In RealAudio's® case, this is based on Real Time Streaming Protocol (RTSP) and Progressive Networks Audio (PNA). Once the request for the presentation is accepted by the server, the requested file is sent via a one-way UDP (User Datagram Protocol) channel. Synchronized Multimedia Integration Language (SMIL) files, are the files that coordinate the delivery and playback of the files as they are sent in small packets, essentially acting as a digital conductor. If video is involved, SMILs become more complex. In order to maintain a constant rate of play, audio clips are typically buffered, meaning that once UDP packets are read, they are briefly cached, or put in a memory queue, where they are then picked up by the audio playback process.

One particular utilization of this technology, Webcasting, refers to providers of audio or video that periodically or constantly stream files over the Internet. Webcasters, often referred to as Internet radio or Internet video, can generally be categorized into two groups: those that transmit several different channels and genres of uninterrupted, programmed music (Spinner, NetRadio, CNN, etc., collectively referred to as Webcasters) or video, and those that simply stream traditional radio station broadcasts over the Internet. Tapping into these sites allows listeners to hear broadcasts from virtually anywhere in the world, thereby breaking the traditional model of only being able to receive broadcast from local stations within receiving distance. Additionally, developed software such as Shoutcast, has enable individual Users and computer owners to Webcast media from home computers, again breaking the traditional model of only having established broadcasters and corporations broadcasting media over Web.

Unfortunately, once streaming begins, the stream is difficult to record or save on a hard disk or other storage media for playing at a later time. Although some companies have developed software which enables Users to store streamed media, the application of the software is limited, if for no other reason than the fact that the entire stream, from the very beginning to the very end, is difficult to record and Users must activate the software themselves.

Notwithstanding the foregoing there exists a need for a method and apparatus to enable Users to easily find a desired work that is being broadcast or will be broadcast in the future over a Global Communication Network (GCN) and legally make personal copies of music and other media provided over a GCN when the media is available to users.

### SUMMARY OF THE INVENTION

The current invention comprises a time shifting method for the receipt and recordation of broadcasts of audio and video (referred to generally herein as “Webcasts,” the person or organization performing the Webcast is referred to herein as a “Webcaster” or “Webcasting Station”) over an Internet, Extranet, Intranet or a relay from a satellite (herein collectively referred to as a Global Communication Network or “GCN”). Additionally, the method may comprise a search engine that 1) monitors Webcasting Stations to determine when, if ever, a User desired Work of Authorship (herein referred to as a “Work”) is made available, by optionally using a Database, for a) real time receipt for a User, as in streaming technology, and/or b) for immediate downloading to a User and 2) provide the desired Work to a user.

The method enables a User to find and obtain a desired Work that is currently, or in the future going to be, Webcast or made available for downloading over a GCN by searching designated Webcaster's stations/sites and waiting for at least one Webcaster to Webcast the User desired Work. The method enables a User to receive and optionally record the Work in real time or immediately download the Work for personal use onto a general-purpose computer.

In other words, generally the method searches GCN radio and video stations and focuses on the particular ones that are most likely to provide the User designated work. Once, if ever, the User designated work is Webcast over a GCN or made available for downloading, the method makes the User a personal recording of the Webcast on a recording unit designated by the User.

Additionally, the Work may be Webcast and/or made available for immediate downloading by a User, as described above and then recorded or saved (herein collectively referred to as “recorded”) on a recording device designated by a Server and then downloaded by the User or a second User from the Server at the request of the User.

In an alternative, but related embodiment of the invention, the software is installed on a digital broadcast receiving unit, e.g., a satellite radio receiver. The receiver is capable of receiving multiple channels (“stations” or “frequencies”) of media provided over a GCN. The software polls the stations, essentially “looking” for a song(s) or video(s) that have been selected by a User and entered into a database readable by 1) the receiving unit and 2) the software installed on the digital broadcast receiving unit. When, if ever, the software determines that a selected song(s) or video(s) is being provided or about to be provided, on any of the polled channels, the software initiates commands to alert the User such that the User can select to listen to or view the song(s) or video(s) by changing the current station to the appropriate station and then optionally record the song of video.

### DETAILED DESCRIPTION OF THE INVENTION

The present method involves a User and User Computer (hereafter generally referred to as “User”) initiating a search of a database for a Work(s) of Authorship (hereafter referred to as a or the “Work”), selecting or designating a Work to 1) receive as a download and/or 2) receive in real time and/or record (if in streaming or similar format), and a Server computer (referred to herein as a “Server”) communicating to the User when (immediately or sometime in the future with an approximate time and date) and where (i.e., the appropriate Webcasting URL) the Work is to be Webcast or made available for downloading or receipt over a Global Communication Network (GCN) so that the User may download or receive and/or optionally record the Work. Specifically, the User may select to download or record the Work on the User's general-purpose computer or other designated storage media or device.

To perform a preferred embodiment of the method, a User should use a Central Server Computer (a Server), at least one communication device and communication software. The Server typically has access to at least one, preferably 3 or more, of the following parts of interest: 1) An Authorship Database, 2) A Time Database and optionally 3) A User Database. The Server may also comprise an optional fourth database: the 4) URL Database. A fifth part of the Server is, of course, the computer through which the Server establishes a link with the/a Global Communications Network and/or Users.

As used herein, a Webcaster may also be a User as well as a Database Information Provider (described in more detail below).

The below-described databases may be combined into one or more databases. The database may be typically stored on a computer, preferably the Server. Herein, the databases in any variation or combination, and in any storage media such as tape drives, hard-drives, optical drives, floppy disks etc., are referred to as the Database.

1) Authorship Database

The Authorship Database comprises designations of Works. Typically, and as used herein, a Work comprises one or more of songs, books, movies, movie shorts, educational films, pre-recorded sports events, simulcasts, etc., and any other type of “Work of Authorship” as defined by the Copyright laws. The designations may be titles, segments of titles, key phrases, key words, etc. contained within a Work or commonly used to reference a particular Work, as understood by one of skill in the art, for example the designation “Melancholy Baby” for the song “Melancholy Baby.”

The Authorship Database or a separate database may also contain 1) the URL of a Webcaster (defined as who performs the Webcast) that shall perform, play, display, etc., the Work over a GCN or 2) a URL of a User that may Webcast or make the Work available for downloading over a GCN.

The Authorship Database may be updated. Preferably, the Authorship Database is updated daily. Most preferably, the Authorship Database is updated continuously by signals and communications sent from Users and Webcasters, in this capacity collectively referred to as from Database Information Providers or “DIPs”, to the Server. In another embodiment described below, the update from a DIP may also be sent directly to a database used by a particular User.

The Authorship Database may also be updated from other DIPs such as members of the recording industry. Members include, but are not limited to, BMI or ASCAP, Sony Pictures, MGM, news providers such as CNN, and other audio and video producers.

The method of updating databases is generally well known to one of skill in the art. For completeness, the method of updating the Authorship Database in particular, as well as other databases useful with the present invention, is set forth in more detail below. The method typically involves a DIP communicating with the Server (or, in a less preferred embodiment, directly with a User) via a GCN and providing updated information to the Server (or User in an alternative embodiment, as described below). The DIP communication with the Server and/or User is described in more detail below.

Alternatively, the Server or DIPs may poll, scan, or use any other method of scanning or searching apparent to one of ordinary skill in the art upon reading this disclosure, (such searching is collectively referred to herein as “polling” or “to poll”). Typically, the method involves polling appropriate URLs or satellite radio stations as often as is technologically possible, depending on the number of URLs to poll. Typically polling is done for each URL at least once every 0.01 seconds to 3 minutes seconds. Preferably, polling and/or updating of a database is initiated at least once every 0.01 to 10 seconds. Completion of the polling and/or updating of the database may take variable amounts of time depending on the number of URLs polled and the size of the Database.

The format of the Work of Authorship provided over a GCN may be MPEG (MP-3, MP-4, etc.), file extensions such as .JPG, .WAV, as well as high definition television, DivX, codec formats, such as streaming audio or video, text or any other media format that is appreciated by one of skill in the art.

2) Time Database

A second database, the Time Database, contains the approximate date and approximate time the Works described in the Authorship Database are to be provided to Users over a GCN. This second database may also be updated. Preferably, the database is periodically updated. Most preferably, the Time Database is continuously updated.

Similar to above, the Time Database may be updated by DIPs. Although the DIPs may 1) supply the appropriate approximate times of a Webcasting of a Work, or 2) the time that the work will be made available for direct downloading, it is more preferable that the Time Database be updated by the Server or User computer polling the DIP's URLs and using software to update the Time Database from the information provided by the DIPs. In other words, the computer polls the DIP's URLs to determine which works are currently being Webcast, will be Webcast or have recently been made available for downloading, and thereby updates the Time Database accordingly.

3) User Database

The third database is a database of information pertaining to Users of the Server. In particular, the database typically contains at least one of the following: name of a User, e-mail address of a User, and the URL of a User or IP address of the User. The database may optionally contain data indicating whether the User is currently using the Server or communicating with the Server. The User Database may also be updated in the manners described below.

This particular database facilitates communication between the Server and User as well as between particular Users, thereby enabling a “peer-to-peer” capability of the method.

4) URL Database

The URL Database is a database of the Internet addresses (Internet Protocol Addresses or URLs, collectively referred to herein as URLs) of the Webcaster of the Works or addresses of other Users that may make a Work available for downloading. This database may also include satellite radio and video stations that are digitally broadcasting video and audio.

Further, it is not necessary for the Database to be in the vicinity of the Server computer hardware. So long as the Server can communicate information from the Database to Users and DIPs, the Database may be remote from the Server.

Any of the Databases may be updated in any manner conventional in the art, as described above. With reference to the Works of Authorship Database, the Server computer or User computer typically polls one or more Databases, preferably the URL database, and establishes communication with the Webcaster at each URL and determines from that communication which Works are scheduled for future Webcasts, are currently being Webcast, or are available for downloading over a GCN.

The Server or User software then updates one or more of the remaining Databases, preferably the Time Database.

Once the Database is updated, the software installed on the Server or User computer may receive instructions from a User to 1) receive the Work or 2) download the Work when it is made available, at the appropriate time and 3) optionally initiate recordation of the Work from specified URL, as per the instructions supplied by the User.

As described above, DIPs may supply the information directly to the appropriate Database, wherein the database is then updated. In this embodiment, it may not be necessary to poll each URL to determine which Works are to be Webcast or are currently being Webcast or are available for downloading over a GCN. In other words, Webcasters supply to the Server or User a “playlist,” such that the software on the Server or User's Computer can initiate commands to establish communication with the appropriate URL and initiate 1) receipt or 2) receipt and recordation of the data provided from a DIP specified URL at a time indicated on the “playlist” provided by a DIP.

However, if one or more Webcasters are Webcasting the same or similar works at the same or different times, as indicated by DIPs or by comparing data in a Database, the Server or User may optionally poll the Database to determine and select which Webcast is most appropriate for downloading or receipt and/or recordation of the Work based on instructions from the User.

The second component of the invention comprises communication software that facilitates communication between the Server and DIPs, such as GCN radio stations, GCN video stations and other Webcaster's URLs. The software may also enable direct (directly to the Server) or indirect (via an Internet service provider such as America On-Line®) communication between the Server and Users.

A third component of the invention comprises a communication device which may comprise a recording unit designed to receive and optionally record a Work when the Work is provided over a GCN. Typically, the communication device is a general-purpose computer containing software which enables the computer to record a Work as it is provided in real time via a GCN. However, as described in more detail below, the recording device software may be modified to 1) initiate direct downloading 2) initiate receipt and recordation of the designated Work at a time the Work is made available by a Webcaster over GCN, or 3) initiate receipt and recordation at a time designated by the Server, User or Webcaster, which may or may not be the same time as when the work is Webcast over a GCN.

Typically, in one embodiment of the invention, Webcaster(s) may provide to the Database and/or Server and/or User when (the approximate time) and from where (the Webcaster's URL) a Work is to be Webcast over a GCN. Lastly, the Webcaster may supply to the Database and/or Server appropriate designations of the Work, as described above. As described above, this information provided by the Webcaster may be incorporated into one or more parts of a Database.

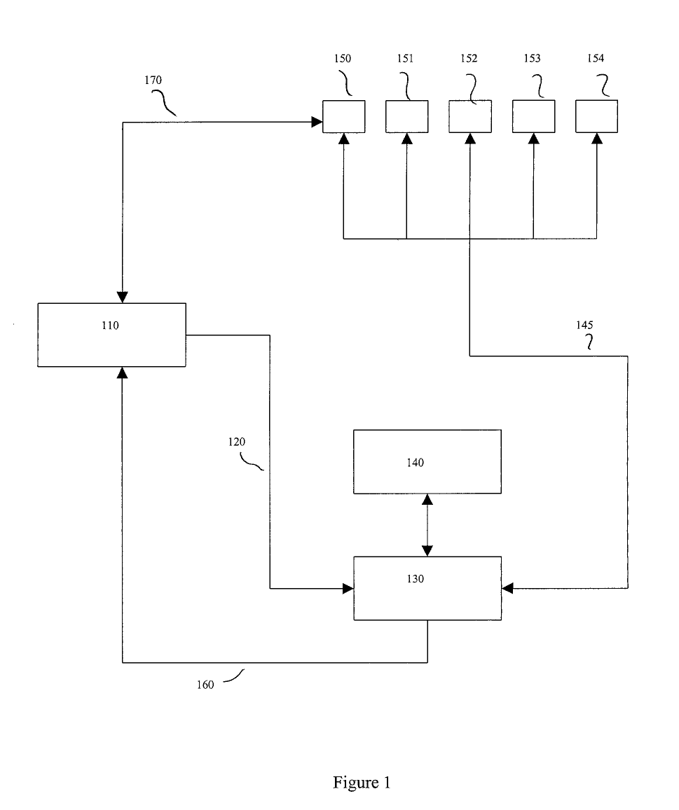

With reference to FIG. 1, in the most preferred embodiment, a User 110 establishes communication with a Server 130 through the use of a User's general purpose computer or other device and/or software that enables communication over a GCN 120, as detailed above. The User communicates with the Server via a computer or other device and typically a keyboard, mouse or other input device.

Once the User 110 establishes communication with the Server 130, the User 110 inputs into the User's computer one or more specific selections or appropriate general designations of a Work (e.g., lyrics or other information such as producer, artist, title, etc., as described briefly above) that the User 110 wants to make a personal copy thereof The User 110 then communicates the selection(s) to the Server 130.

Upon receiving the communication from the User 110, the Server 130 polls the Database 140 for the Work and/or other information selected by the User 110 based on the information provided by the User 110.

The Server 130 then optionally communicates, via a GCN, to the User 110 at least one of the following: 1) the time and 2) the URL of at least one web-site that a) is scheduled to broadcast the Work or b) may Webcast the Work at a future time over a GCN or c) is currently Webcasting the Work.

With respect to parts a, b, and c outlined above, the Server 130 monitors and updates the Database 140 by monitoring the URLs of current broadcasts or information provided by at least one Webcaster, and as shown in FIG. 1, Webcasters 150-154. The Server 130 then compares the updated Database of Works that are currently being broadcast or about to be broadcast with the requests by the User.

The Server 130 establishes a communication with URLs 150-154 via GCN 145 and polls the broadcasting URLs 150-154 and subsequently 1) communicates to the User via a return communication 160 that the work is being broadcast or about to be broadcast on a particular URL such that the User may initiate receipt and/or recordation of the designated Work in a manners described above via a communication 170 with a specific URL 150.

Additionally, the Server may provide URLs of Webcasters that may provide Works over a GCN that may interest the User as determined by comparing the User's request with other User's requests and/or using an algorithm installed on the Server.

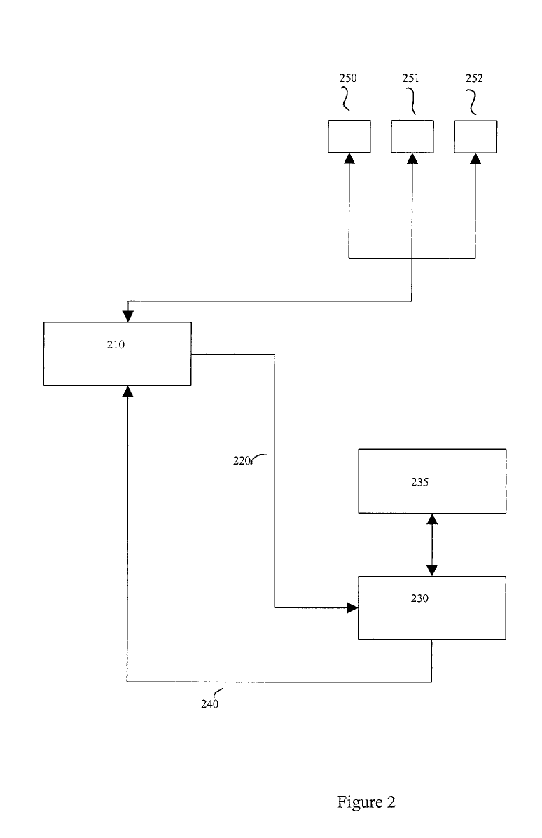

In an alternative embodiment shown by FIG. 2, the User 210 may establish communication with one or more URLs supplied by the Server 230 at a designated time. Essentially, the User 210 established communication with the Server 230 and inputs a request to the Server via GCN 220. In response, User 210 receives one or more URLs, represented in FIG. 2 by URLs 250-252, from the Server 230 via GCN 240 that may provide the designated Work. The URLs 250-252 are obtained from communication between the Server 230 and Database 235. The User then establishes a communication with the URLs 250-252 via GCN 260 and polls the URLs 250 and determines when, if ever, the designated Work is available for direct download, receipt in real time and/or optionally initiates recordation of the Work. In this embodiment, the User 210 may also generate a local database of URLs to poll. Therefore, it may be possible to conduct the method of the invention wherein the User's computer becomes, in part, the Server computer described above with reference to FIG. 1. The User 210 then polls the URLs 250-252 for the designated work and upon locating the designated work may initiate downloading, receipt and/or recordation of the Work to the User or other specified Recording Unit RU).

As briefly described above, the Recording Unit records data received by a general-purpose computer. In a particular embodiment, the RU records the data received from a URL after the data has been received by the User's computer, but before or during the data presentation to the User via television, monitor or speaker.

Alternatively, as per instructions from the User, the Server records the selected Work for the User employing a Recording Unit located in communication with the Server, which is not the User's general-purpose computer. This feature has the advantage of reducing the communication bandwidth requirements of a User's communication link to the Server or Webcaster. Specifically, because the User's computer is not directly receiving the data from the Webcaster or polling one or more Webcaster's, the demands placed upon the communication link between a GCN and the User are significantly reduced. This feature also has the added advantage of reducing the requirements placed upon the Webcaster's link to a GCN. Specifically, because the Server is communicating directly with the Webcaster that is providing the desired Work, only one communication link may be established between the Server and Webcaster. Therefore, the Webcaster does not have to communicate directly with multiple Users, thereby reducing the demands placed upon the communication link of the Webcaster. This feature also has the added benefit of facilitating recordation by multiple Users. Specifically, if multiple Users select a particular Work for recordation, when, if ever, the Work becomes available for direct downloading and/or recording in real time, the Work may only need to be downloaded and/or recording once by the Server. Then, at the request of a User that requested the designated Work, the saved Work may be downloaded to the User's computer from the Server. Alternatively, at the request of the User, the Server may download the Work to a storage media designated by the User, for example another computer or even to a DIP computer.

Lastly, when used in conjunction with the feature of the Server polling the URLs for a Work specified by a User, the feature of initially recording the Work on a Recording Device other than the User's general purpose computer provides a greater reduction in demands placed upon the communication link between the Global Communications Network and the User's computer.

Alternatively, the Server may communicate with the User's computer and optionally provide one or more URLs of Webcasters (as described above, the broadcasting URL may be another User or Webcaster. However, as described in more detail below the Webcaster may also be the Server) and/or activate the User's web browser to link to one of more of the provided URLs. Once the Webcast of the designated Work begins, the Server communicates with the User's computer to initiate recordation of the Work, if desired or to receive the work if streaming is all that is desired by the User. Essentially, the Server controls the User's computer and the User's Recording Unit to record the selected Work. This embodiment has the advantage of facilitating recordation of a Work without additional instruction provided to a computer by the User other than the selection of the Work. The Server determines when actual recordation of the Work is to be initiated.

Alternatively, the above-described embodiments may be modified by the User downloading a Server control program to the User's computer. In this particular embodiment, the Server also provides at least one part of the Database to the User. The User may optionally update the Database by communicating with the Server and request a Database update. The User may also optionally manually update the Database or by communication with DIPs. Such an embodiment enables the User to determine what Work is to be recorded and poll URLs to determine when, if ever, the Work is Webcast after severing a link to the Server.

The program optionally activates the User's computer web browser and/or Recording Unit to record the selected Work(s) when the Work is provided. This feature facilitates the User's computer in polling the URLs provided by the Server and to receive data from one or more URLs and initiate recordation of the appropriate Webcast from the appropriate URL, as designated by the User. Although the demands placed on the communication from the User over a GCN increase proportionately based upon the number of URLs supplied by the Server that are polled by the User, this feature has the advantage of reducing the demands placed on the Server's communication link with a GCN because the Server does not divert resources to poll the URLs in the URL database for the specified Work. This embodiment also provides an advantage wherein, after establishing communication with the Server, selecting at least one Work and receiving a portion of a Database that may contain URLs of Webcasters, the User's computer does not require additional communication from the Server. The control program may be downloaded directly from the Server or emailed to the User from the Server.

Alternatively, a Webcaster (who may also be a User) supplies to the Server a signal that a particular Work is about to be played. In this embodiment, the Webcaster updates the Database rather than the Server or User's Computer polling the Database for the Work to update a Database. The signal may comprise a Database update, playlist or other type of communication indicating that the Work is about to be played. The Server may optionally communicate the signal to the User, thus enabling the User to prepare to engage the User's Recording Unit well before the Work is broadcast. This feature provides the advantage of enabling Users to plan ahead when to record the Work as well as facilitating the recordation of an entire Work.

In an alternative embodiment, after a Webcaster supplies to the Server data indicating that the work is about to be played, the Server communicates with the User that the Work is about to be played. Essentially, the Server acts a middleman, facilitating communication between a Webcaster and a User. The User may optionally record the Work by the appropriate methods described above. In this embodiment, the Server may record the work for the User (as described above) and subsequently store the recorded work on a User or Server specified media until the work is removed and or erased by the User or Server.

Alternatively, a Webcaster uploads the entire Work to the Server. The Server then stores the Work for the Webcaster. The Webcaster then specifies a time or times, if not immediately, the Server should Webcast the work over a GCN (typically by the Webcaster sending a signal or communicating with the Server or prespecifying a time for Webcasting when the work is initially uploaded to the Server). In this embodiment, the Server becomes a Webcaster, but may Webcast the Work at the time specified by Webcaster that uploaded the work to the Server. The Server then provides the work for direct downloading, reception and/or recordation of the Webcast of the Work over a GCN. A User may initiate recordation of the Webcast of the Work using the applicable methods described above directly from the Server. Preferably, in the embodiment wherein a control program is provided to the User, the User may poll designated URLs (as described above), of which the Server would be designated as at least one URL and thereby the User could initiate downloading (if applicable), receipt and/or recordation of the Work. Alternatively, similar to the embodiment wherein the Work is stored on a storage device in communication with the Server, the Server polls the Database of Users that have requested the Work and the Server then, upon Webcasting, initiates recordation or downloading of the Webcast to a storage device specified by the Users.

Alternatively, the Webcaster may transfer broadcasting control to the Server. In such an embodiment, the Webcaster may select a time and URL from which the data is to be broadcast from and communicates that information to the Server. The Server then contacts appropriate Users that have designated the Work. The Server then indicates that the Webcaster is going to Webcast the designated Work at the time specified. The Server and User may also optionally indicate when to terminate the broadcast.

The time specified could be immediately or a time in the future.

Any of the described embodiments may be optionally combined with other embodiments.

When the broadcast is complete, the Server optionally communicates to the User requesting the User to stop recording the broadcast. Alternatively, the Server optionally stops recording the Webcast. If the file is downloaded directly, the downloading ends when file transfer is complete. Additionally, the recorded or downloaded work may be encoded on the User designated storage device such that only one copy is available and subsequent copies are not capable of being used by other computers. Such encoding algorithms are well understood to one of ordinary skill in the art.

Any of the alternatives described above may also comprise the Broadcaster or Server providing advertising in conjunction with the communication to the User or Server. The advertising is communicated to the User or Server before, during or after the work(s) of authorship is broadcast.

In another alternative embodiment of the invention, the Server is optional. Similar to the control program above, the User compiles a database of Work designations and Webcaster URLs. The URLs may be supplied by the User manually or may be supplied by Webcasters or any other method conventional in the art. The User's general purpose computer then polls at least one video or audio Webcaster URL and compares current Webcasts of the Webcasters with the User's database of designated Works. Once the general purpose computer determines that a particular User designated Work is available for direct downloading, is being broadcast or will be broadcast, the general purpose computer alerts the User so that the User may receive, download and/or record the work at the User's option.

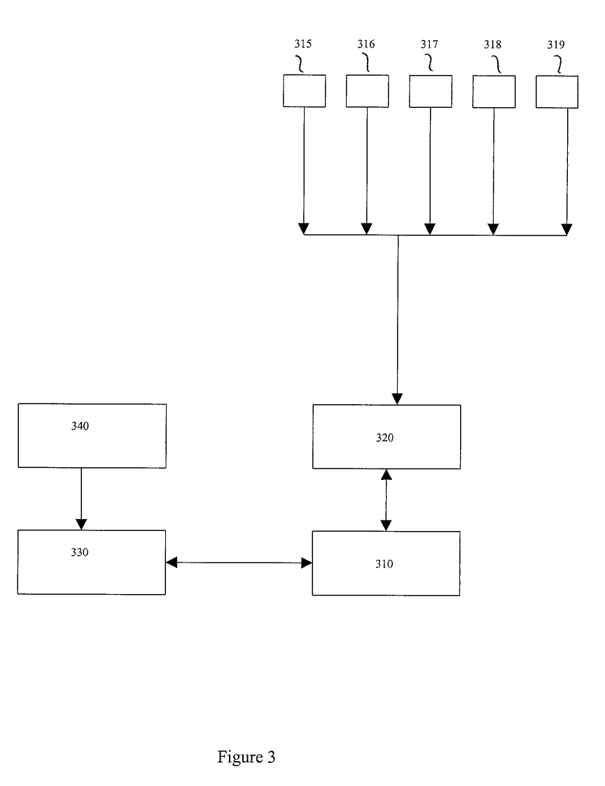

This particular embodiment has particular use with digitally broadcast satellite radio and video and in particular satellite radio received by cars. As shown in FIG. 3, the general-purpose computer 310 polls the satellite stations 315-319 received by the receiver 320 and compares the data received by the stations 315-319 to a Database 330 on the general-purpose computer 310. The database 330 comprises designations of Works (similar to above) generated or provided by a User 340 (via a floppy disk, memory stick, keyboard or other method apparent to one of skill in the art). When, if ever, the general purpose computer 310 determines that a designated work is available on a particular station 315-319, the general purpose computer 310 alerts the User 340 so that the User may, at the User's discretion, download, receive and/or initiate recordation of the Work.

The invention is now described with reference to the following examples. These examples are provided for the purpose of illustration only and the invention should in no way be construed as being limited to these examples but rather should be construed to encompass any and all variations which become evident as a result of the teaching provided herein.

### EXAMPLES

### Example 1

A User provides a general-purpose computer. The general-purpose computer has software installed on it which facilitates communication via the Internet and a standard cable modem having a data transfer rate of about 30 megabytes per minute. The cable modem and software enables the computer to establish a communication link with at least one other computer over the Internet. The User then establishes a communication link between the general-purpose computer and a central server computer through the Internet.

Using a computer program downloaded from the central server, the user enters into the computer a song the user wants to receive and optionally record. In this case, the user selects to both receive and record the work “Melancholy Baby.” After entering the selection into the general-purpose computer, the general-purpose computer communicates the requested work “Melancholy Baby” to the central server computer.

In response to the communication, the general-purpose computer receives from the central server computer a database of 3 Websites that are most likely to play the User requested work over the Internet.

The User's computer then establishes a communication link with the provided Websites. Thereafter, the User's computer polls each of the Websites to determine if the work is currently being Webcast or will be Webcast over the Internet on any of the central server provided Websites. The process of polling the Websites is repeated until the song “Melancholy Baby” is found to be playing. If desired the User may stop polling all of the provided Websites if one of the Websites indicates to the general purpose computer or the general purpose computer determines (using pre-installed software) that the song “Melancholy Baby” is about to be played (in about 1 hour). However, in this case, the option to prematurely stop polling has not been selected. Therefore polling of the Websites continues until the song “Melancholy Baby” is actually played over the Internet (a GCN).

Once the general-purpose computer determines that the work “Melancholy Baby” is being played (by comparing the User input data with data received via the GCN), the general-purpose computer receives the song for the User and plays the work through the speakers attached to the general-purpose computer. Because the User selected to also record the song, the general-purpose computer also records “Melancholy Baby” onto the hard drive of the general-purpose computer so that the work can be played later by the User.

### Example 2

A User provides a general-purpose computer. The general-purpose computer has software installed on it which facilitates communication via the Internet and a standard cable modem having a data transfer rate of about 30 megabytes per minute. The cable modem and software enables the computer to establish a communication link with at least one other computer over the Internet.

The User then establishes a communication link between the general-purpose computer and a central server computer through the Internet.

Using a computer program downloaded from the central server, the user enters into the computer a song the user wants to receive and optionally record. In this case, the user selects to both receive and record the work “Melancholy Baby.” After entering the selection into the general-purpose computer, the general-purpose computer communicates the requested work “Melancholy Baby” to the central server computer.

In response to the communication from the general-purpose computer, the central server compares the requested work with a database of requestable works. After comparing the request with the database, the central server establishes communication with 3 Websites that are most likely to provide the requested work “Melancholy Baby” in a streamed audio format. The central server then regularly polls the 3 Websites at about 0.01 second to 3 minute intervals to determine if the requested work is being provided.

Once the central server computer determines “Melancholy Baby” is being played by comparing the signal from the URL with the User request, the central server begins to record the requested work for the User.

### Example 3

A User provides a mobile general purpose computer, and specifically the mobile general purpose computer of this Example is positioned in a car. The general purpose computer has software installed on it that enables the general purpose computer to receive digital transmissions from a satellite radio broadcaster. The general purpose computer also has software on it that enables the general purpose computer to monitor songs from different stations that are currently being (or will be) broadcast from the satellite.

In this particular embodiment an Agere chip set first processes three including sets of signals that contain the same information (two being time-division multiplexed, or “TDM,” from the satellites, and the other coded orthogonal frequency-division multiplexed, or “COFDM,” from the terrestrial antennas). The TDM and COFDM signals are processed and filters by radio frequency (RF) and intermediate frequency (IF) chips to an IF output of 75 MHz. An analog-to-digital converter undersamples the 75-MHz IF to 60 megasamples for a digital image with 15 MHz of bandwidth of encoded signals (two TDM and one COFDM).

The signals are then digitally filtered and demodulated before being combined into 100 channels of radio signals by a maximum ratio combiner. A concatenated decoder chain IC is used to select a specific channel for playing through a digital audio processor-which contains an Agere 1600 digital signal processor (DSP) core and an ARM RISC processor.

The User enters the title of a song “Melancholy Baby” into the general purpose computer (either manually using a touchscreen or by inserting a memory device into the computer that contains the designation of the song and uploading that information into the general purpose computer). The general purpose computer polls at least two of the different received stations every 10 seconds to determine if the requested song is being played by comparing the information provided by the signal from the satellite with the User request.

Once the general purpose computer determines that the song is being played, the general purpose computer alerts the User that the song is being played by visual display and an audible beep, wherein the visual display indicates what station the song is being played on such that the User may change stations, if necessary, to listen to the song.

### Example 4

The User provides a general purpose computer as in Example 3. However, the general purpose computer has additional software installed on it such that as songs are being played, the User may save a designation of the song into a database on the general purpose computer to create a playlist. The general purpose computer is then directed to poll/search the radio stations for the songs on the playlist and alert the User when a song from the playlist is being played on any station that may be polled by the general purpose computer. This embodiment provides the advantage of a dynamic database, that is updated periodically by a User as the User's preferences change.

### Example 5

The User provides a general-purpose computer as in Example 3. However, the general purpose computer has additional software installed on it such that as songs are being played on different stations, a database is updated on the general purpose computer indicating when at a future time a desired song is to be played. The database is updated by receiving signals from the satellite radio broadcasting station.

The User enters a designation of “Melancholy Baby” into the database in communication with the general purpose computer by inputting a Sony Memory Stick™ that contains the database update into a dataport coupled to the general purpose computer.

The general purpose computer then polls the stations searching for the song “Melancholy Baby.” A broadcaster sends a signal indicating that the song “Melancholy Baby” will be played in 30 seconds on a particular station capable of being received by the general-purpose computer. The general-purpose computer then indicates to the user by way of a display that the song “Melancholy Baby” is about to be played and indicates the time left until the song is played and the particular station that will play the song. The User may then decide whether or not to listen to the song at the appropriate time by changing the channel on the satellite radio receiver.

### Example 6

A User provides a mobile general-purpose computer. The general-purpose computer has software installed on it that enables the general-purpose computer to receive digital transmissions from a wireless GCN connection. The general purpose computer also has software on it that enables the general purpose computer to monitor songs from different stations that are currently being (or will be) broadcast on the Internet that are receivable by the wireless GCN connection.

The User enters the title of a song “Melancholy Baby” into the general purpose computer and the general purpose computer polls the different stations that are being Webcast and received by the User's wireless GCN to determine if the requested song is being played. Once the general purpose computer determines that the song is being played, the general purpose computer alerts the User that the song is being played and what URL the song is being played on such that the User may link to the appropriate URL, at the User's option, to listen to the song.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method of obtaining data from a global communication network comprising the steps of:
A. Providing a general purpose computer, wherein said general purpose computer is adapted to establish a communication link with at least one other computer over a global communication network;
B. Establishing a communication link between said general purpose computer and a central server computer through said global communication network;
C. Using a computer program enabling a user of said general purpose computer to select a type of data to receive;
D. Inputing said type of data into said general purpose computer;
E. Communicating said type of data to said central server computer;
F. Receiving at least a portion of a database from said central server to said general purpose computer, wherein said portion of a database comprises at least one URL;
G. Establishing a communication link with said at least one URL provided by said central server computer;
H. Polling said at least one URL for said data;
I. Receiving information from said at least one URL;
J. Comparing said information from said at least one URL with said selected type of data;
K. Determining when said type of data is available from said at least one URL; and
L. Receiving said data when said data is available from said URL.

2. The method of claim 1, wherein said type of received data comprises streaming audio.

3. The method of claim 1, wherein said type of data comprises streaming video.

4. The method of claim 1, wherein said type of data comprises a combination of streaming audio and streaming video.

5. The method of claim 1, wherein said portion of a database further comprises time data indicating when said type of data will be available to general purpose computers.

6. The method of claim 1 further comprising the step of recording said data on a storage media.

7. The method of claim 6, wherein said storage media is a hard drive.

8. The method of claim 6, further comprising the step of encoding said data, wherein said encoded data is available only to the general purpose computer which received or recorded said data.

9. The method of claim 1 further comprising the step of providing said data to a user from said general purpose computer through at least one of a monitor, television and speaker.

10. The method of claim 1, wherein said data is available in portions over time and said general purpose computer receives said data in real time as it is available from said at least one URL.

11. A method of obtaining data comprising the steps of:
A. Establishing a database comprising URLs and at least one of the following types of data:
a. Work of Authorship
b. Author
c. Time of Webcast;
B. Establishing a communication link with at least one of said URLs;
C. Updating said database with information provided by said at least one of said URLs;
D. Receiving a request for data from a user of a general purpose computer;
E. Polling said updated database for said requested data;
F. Comparing said updated database with said request for data;
M. Determining when said data is available from said at least one URL; and
G. Receiving said data from said URL when said data matches said request and when said data is available from said URL.

12. The method of claim 11, wherein said received data comprises streaming audio.

13. The method of claim 11, wherein said type of data comprises streaming video.

14. The method of claim 11, wherein said type of data comprises a combination of streaming audio and streaming video.

15. The method of claim 11, wherein said data is made available to a user of said general purpose computer.

16. The method of claim 11 further comprising the step of recording said data on a storage media.

17. The method of claim 16, wherein said storage media is a hard drive.

18. The method of claim 16, further comprising the step of encoding said data, wherein said encoded data is available only to the user of said general purpose computer.

19. The method of claim 11, wherein said data is available in portions over time and said central server computer receives said data in real time as it is available from said at least one URL.

20. A method of obtaining data from a global communication network comprising the steps of:
A. Providing a general purpose computer, wherein said general purpose computer is adapted to establish a communication link with at least one other computer over a global communication network;
B. Generating a database of at URLs on said general purpose computer, wherein said URLs are capable of providing data to said general purpose computer over said global communication network;
C. Using a computer program enabling a user of said general purpose computer to select a type of data to receive;
D. Inputing said type of data into said general purpose computer;
E. Establishing a communication link between said general purpose computer and at least one URL;
F. Polling said at least one URL for said data;
G. Receiving information from said at least one URL;
H. Comparing said information from said at least one URL with said selected type of data;
I. Determining when said data is available from said at least one URL; and
J. Receiving said data when 1) said data matches the type of data to receive and 2) is available from said URL.
